(19) United States
(12) Patent Application Publication
(10) Pub. No.: US 2015/0090055 A1
(43) Pub. Date: Apr. 2, 2015

(54) UNIVERSAL MOUNTING ASSEMBLY FOR SENSING DEVICE

(71) Applicant: GOJO Industries, Inc.,, Akron, OH (US)

(72) Inventor: Mark W. Moore, Aurora, OH (US)

(21) Appl. No.: 14/501,379

(22) Filed: Sep. 30, 2014

Related U.S. Application Data
(60) Provisional application No. 61/884,812, filed on Sep. 30, 2013.
(60) Provisional application No. 61/893,106, filed on Oct. 18, 2013.

(51) Int. Cl. G01D 11/30

(52) U.S. Cl. CPC G01D 11/30
USPC 73/866.5

(57) ABSTRACT

A sensing assembly includes a sensing device and a mounting assembly. The mounting assembly includes a base portion. The mounting assembly includes an extension portion movably attached with respect to the base portion. The mounting assembly includes a connection portion movably attached with respect to the extension portion. The mounting assembly includes a support portion movably attached with respect to the connection portion. The support portion supports the sensing device.

### CROSS-REFERENCE TO RELATED APPLICATIONS

This application claims priority to U.S. Patent Application No. 61/884,812, filed on Sep. 30, 2013, and also claims priority to U.S. Patent Application No. 61/893,106, filed on Oct. 18, 2013, the entire disclosures of both applications are hereby incorporated by reference.

### TECHNICAL FIELD

The instant application is generally directed towards a mounting assembly. For example, the instant application is directed towards a mounting assembly for a sensing device.

### BACKGROUND

Sensing devices can sense the presence of a person within an area, such as a room. Sensing devices can be positioned within the area and oriented towards an entrance/exit of the room. Sensing devices can be used, for example, in schools, hospitals, nursing homes, factories, restaurants, etc., where it may be desirable to monitor a person's entrance/exit into and out of the area.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an example, a sensing assembly comprises a sensing device. The sensing assembly can attach the sensing device to a surface. In an example, the mounting assembly is movable with respect to the surface about at least two axes.

In another example, a sensing assembly comprises a sensing device and a mounting assembly. In an example, the mounting assembly comprises a base portion, an extension portion movably attached with respect to the base portion, a connection portion movably attached with respect to the extension portion, and a support portion movably attached with respect to the connection portion. In an example, the support portion supports the sensing device.

In another example, a mounting assembly for a sensing device comprises a base portion and an extension portion movably attached with respect to the base portion, wherein the extension portion is movable about a first axis. In an example, the mounting assembly comprises a connection portion movably attached with respect to the extension portion, wherein the connection portion is movable about a second axis and about a third axis. In an example, the mounting assembly comprises a support portion movably attached with respect to the connection portion, wherein the support portion is movable about a fourth axis. In an example, the support portion supports the sensing device.

The following description and annexed drawings set forth certain illustrative aspects and implementations. These are indicative of but a few of the various ways in which one or more aspects can be employed. Other aspects, advantages, and/or novel features of the disclosure will become apparent from the following detailed description when considered in conjunction with the annexed drawings.

### DESCRIPTION OF THE DRAWINGS

FIG. 1 is an illustration of an example sensing assembly;

FIG. 2 is an illustration of a partially exploded mounting assembly of an example sensing assembly;

FIG. 3 is an illustration of an extension portion of an example mounting assembly;

FIG. 4 is an illustration of an extension portion and a connection portion of an example mounting assembly;

FIG. 5 is an illustration of a first connection device and a second connection device of an example mounting assembly;

FIG. 6 is an illustration of a second connection device of an example mounting assembly;

FIG. 7 is an illustration of a support portion of an example mounting assembly;

FIG. 8 is an illustration of a partially exploded mounting assembly of an example sensing assembly; and

FIG. 9 is an illustration of an example of a mounting assembly of a sensing assembly.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It is evident, however, that the claimed subject matter can be practiced without these specific details. In other instances, structures and devices are illustrated in block diagram form in order to facilitate describing the claimed subject matter.

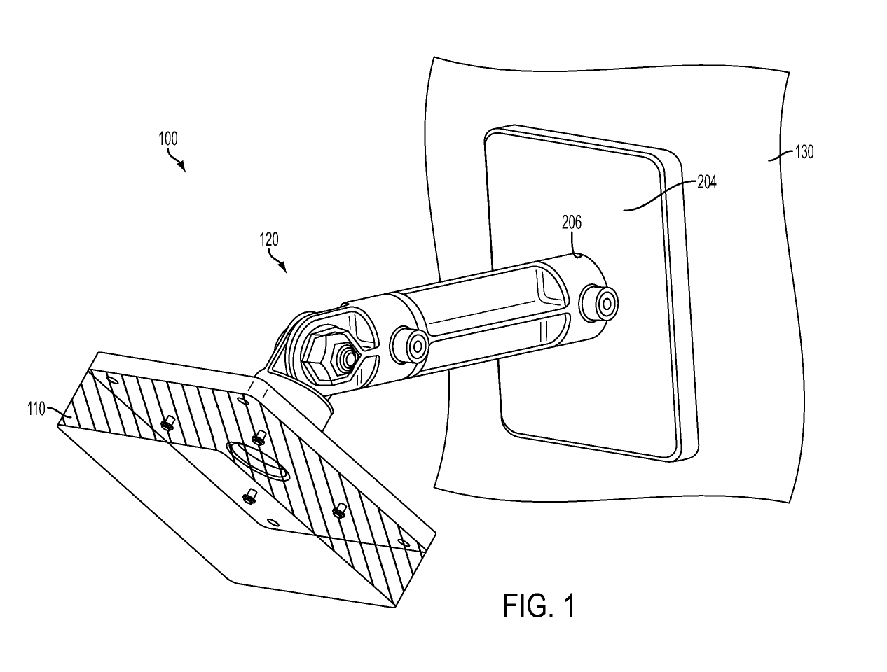

Turning to FIG. 1, a sensing assembly 100 is illustrated. In general, the sensing assembly 100 can be used for sensing a person's presence within an area. In some examples, the sensing assembly 100 can sense entry and exit from the area, such as a room. It will be appreciated that the sensing assembly 100 illustrated in FIG. 1 comprises one of any number of constructions of the sensing assembly 100, as the sensing assembly 100 includes any number of sizes, shapes, configurations, orientations, etc.

In some examples, the sensing assembly 100 can include a sensing device 110. The sensing device 110 can detect a presence of the person within the area (e.g., room, etc.). In an example, the sensing device 110 can include a room monitor sensor that senses entry into and exit from the room. The sensing device 110 includes any number of components that sense a person's entry/exit, including, but not limited to, infrared devices (e.g., transmitters, receivers, etc.), wireless communication devices, etc.

The sensing assembly 100 can include a mounting assembly 120 for attaching the sensing device 110 to a surface 130. The surface 130 includes any number of structures, such as walls, ceilings, doors, windows, or the like. As will be described below, the mounting assembly 120 allows for movement of the sensing device 110 with respect to the surface 130. This movement allows for the sensing device 110 to be directed towards (e.g., aimed, pointed, targeted, etc.) a desired location, such as an entrance (e.g., doorway) to a room. In some examples, by directing the sensing device 110 towards the entrance, detection of the person's entry/exit into and out of the room is improved.

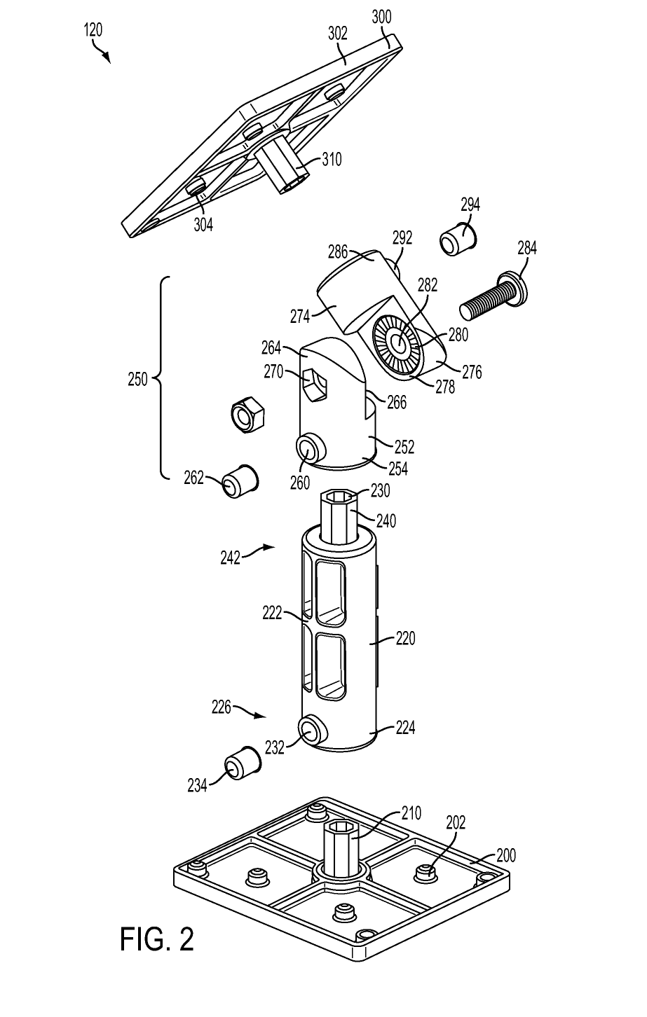

Turning to FIG. 2, the mounting assembly 120 is illustrated. It is appreciated that the mounting assembly 120 is illustrated as being partially exploded for ease of illustration, but, in operation, the mounting assembly 120 may function in a non-exploded, fully assembled state as illustrated in FIG. 1.

The mounting assembly 120 includes a base portion 200. The base portion 200 can be attached to the surface 130 (illustrated in FIG. 1) in any number of ways. In some examples, the base portion 200 includes one or more apertures 202. Fasteners (e.g., screws, nuts, bolts, etc.) can be inserted through the apertures 202 for attaching the base portion 200 to the surface 130. The base portion 200 is not limited to including fasteners, and in other examples, may include adhesive(s), mechanical locking devices, or the like for attaching the base portion 200 to the surface 130.

In some examples, a cover 204 (illustrated in FIG. 1) can be attached to the base portion 200. The cover 204 defines a substantially planar surface that covers and/or is attached to the base portion 200. The cover 204 can include an opening 206 through which a portion of the base portion (e.g., base attachment structure 210) can extend. The cover 204 can be attached in any number of ways to the base portion 200, such as with mechanical fasteners, adhesives, magnets, mechanical locking devices, etc.

The base portion 200 includes the base attachment structure 210. The base attachment structure 210 defines an outwardly protruding extension that projects from the base portion 200. In some examples, when the cover 204 is attached to the base portion 200, the base attachment structure 210 extends through the opening 206 in the cover 204. The base attachment structure 210 can be located on an opposite side of the base portion 200 from the surface 130. The base attachment structure 210 includes any number of sizes/shapes. In an example, the base attachment structure 210 includes an octagonal cross-section. However, the base attachment structure 210 is not so limited, and in other examples, includes any number of polygonal shapes (e.g., regular polygonal), such as by having one or more sides and/or including shapes such as triangles, squares, pentagons, hexagons, heptagons, etc.

The mounting assembly 120 includes an extension portion 220. The extension portion 220 includes a body portion 222. The body portion 222 is elongated and extends generally linearly. The body portion 222 is not so limited, however, and in other examples, may include bends, curves, undulations, or the like, such that the body portion 222 is non-linear.

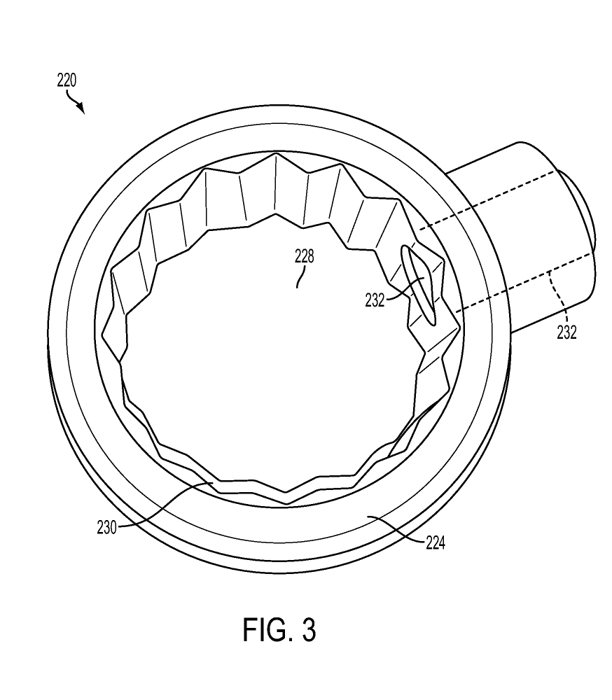

The extension portion 220 can include a first extension attachment portion 224 located at a first end 226 of the body portion 222. Referring to FIGS. 2 and 3, the first extension attachment portion 224 comprises a recess 228 that extends inwardly into the body portion 222. In some examples, the recess 228 has a depth that substantially matches a height of the base attachment structure 210, such that the recess 228 of the first extension attachment portion 224 can receive the base attachment structure 210.

The first extension attachment portion 224 includes any number of sizes/shapes. In an example, the first extension attachment portion 224 includes a polygonal (e.g., a regular polygon) cross-section (illustrated in FIG. 3) comprising a plurality of sides 230. In the illustrated example, the first extension attachment portion 224 includes thirty two sides 230. However, in other examples, the first extension attachment portion 224 includes any number of sides 230, such as by including four sides, six sides, eight sides, etc. The first extension attachment portion 224 is sized/shaped to receive the base attachment structure 210. In the illustrated example, by including thirty two sides 230 (and, correspondingly, sixteen angles), the first extension attachment portion 224 can receive the base attachment structure 210 in sixteen different orientations, thus providing for more finite adjustment of the first extension attachment portion 224 with respect to the base attachment structure 210.

The first extension attachment portion 224 can include a first attachment opening 232. The first attachment opening 232 can define an aperture, recess, space, passageway, etc. that extends through the first extension attachment portion 224 to the recess 228. In some examples, the first attachment opening 232 is sized/shaped to receive a first fastener 234. The first fastener 234 comprises any number of structures, such as screws, bolts, nuts, rivets, nails, or the like. In operation, when the first extension attachment portion 224 receives the base attachment structure 210, the first fastener 234 can be inserted through the first attachment opening 232 and towards the recess 228. As such, the first fastener 234 can contact/engage the base attachment structure 210 to limit inadvertent movement of the base attachment structure 210 within the recess 228. When movement or orientation adjustment is desired, the first fastener 234 can be removed or loosened from the first attachment opening 232, allowing for the base attachment structure 210 to be removed from and/or moved with respect to the first extension attachment portion 224. Accordingly, the extension portion 220 can be movably adjusted with respect to the base portion 200.

The extension portion 220 can include a second extension attachment portion 240 located at a second end 242 of the body portion 222. The second extension attachment portion 240 defines an outwardly protruding extension that projects from the body portion 222. The second extension attachment portion 240 includes any number of sizes/shapes. In an example, the second extension attachment portion 240 includes an octagonal cross-section. In this example, the second extension attachment portion 240 generally matches a shape of the base attachment structure 210. However, the second extension attachment portion 240 is not so limited, and in other examples, includes any number of polygonal shapes (e.g., regular polygonal), such as by having one or more sides and/or including shapes such as triangles, squares, pentagons, hexagons, heptagons, etc.

Referring to FIG. 2, the mounting assembly 120 includes a connection portion 250. In an example, the connection portion 250 includes a first connection device 252. The first connection device 252 is elongated and extends generally linearly. The first connection device 252 is not so limited, however, and in other examples, may include bends, curves, undulations, or the like, such that the first connection device 252 is non-linear.

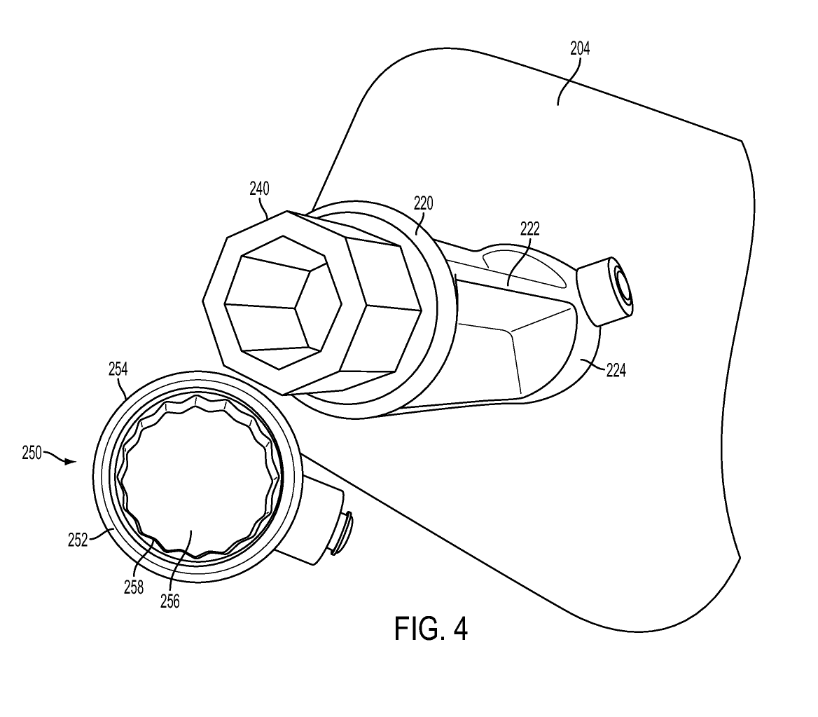

The first connection device 252 includes a first attachment portion 254. Referring to FIGS. 2 and 4, the first attachment portion 254 comprises a recess 256 that extends inwardly into the first connection device 252. The first attachment portion 254 includes any number of sizes/shapes. In an example, the first attachment portion 254 includes a polygonal (e.g., a regular polygon) cross-section (illustrated in FIG. 4) comprising a plurality of sides 258. In the illustrated example, the first attachment portion 254 includes thirty two sides 258. However, in other examples, the first attachment portion 254 includes any number of sides 258, such as by including four sides, six sides, eight sides, etc.

The first attachment portion 254 is sized/shaped to receive the second extension attachment portion 240. In the illustrated example, by including thirty two sides 258 (and, correspondingly, sixteen angles), the first attachment portion 254 can receive the second extension attachment portion 240 in sixteen different orientations, thus providing for more finite adjustment of the first attachment portion 254 with respect to the second extension attachment portion 240.

The first attachment portion 254 can include a second attachment opening 260 (illustrated in FIG. 2). The second attachment opening 260 can define an aperture, recess, space, passageway, etc. that extends through the first attachment portion 254 to the recess 256. In some examples, the second attachment opening 260 is sized/shaped to receive a second fastener 262. The second fastener 262 comprises any number of structures, such as screws, bolts, nuts, rivets, nails, or the like. In operation, the second fastener 262 can be inserted through the second attachment opening 260 and towards the recess 256. As such, the second fastener 262 can contact/engage the second extension attachment portion 240 to limit inadvertent movement of the second extension attachment portion 240 within the recess 256. When movement or orientation adjustment is desired, the second fastener 262 can be removed or loosened from the second attachment opening 260, allowing for the second extension attachment portion 240 to be removed from and/or moved with respect to the first attachment portion 254. Accordingly, the connection portion 250 can be movably adjusted with respect to the extension portion 220.

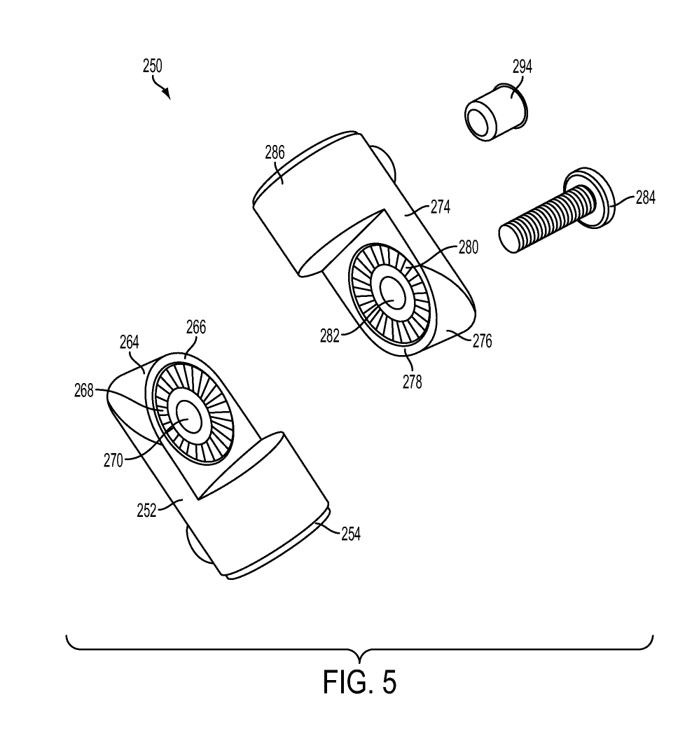

The first connection device 252 includes a second attachment portion 264. Referring to FIGS. 2 and 5, the second attachment portion 264 comprises a first recessed portion 266 that defines a groove, gap, space, etc. In some examples, the second attachment portion 264 includes a first non-planar attachment feature 268 (illustrated in FIG. 5) disposed on a wall defining the first recessed portion 266. The first non-planar attachment feature 268 includes any number of constructions. In the illustrated example, the first non-planar attachment feature 268 defines a generally circular shape, though other shapes are envisioned. The first non-planar attachment feature 268 can include a plurality of raised and recessed portions, defining a generally undulating profile.

The first connection device 252 can include a third attachment opening 270. The third attachment opening 270 can define an aperture, recess, space, passageway, etc. that extends through the second attachment portion 264 to the first recessed portion 266. In an example, the third attachment opening 270 extends through the first non-planar attachment feature 268.

Referring to FIGS. 2 and 5, the connection portion 250 includes a second connection device 274. In some examples, the second connection device 274 is similar in size/shape/construction to the first connection device 252, as the second connection device 274 is elongated and extends generally linearly. The second connection device 274 is not limited to the illustrated structure, however, and in other examples, may include bends, curves, undulations, or the like, such that the second connection device 274 is non-linear.

The second connection device 274 includes a third attachment portion 276. The third attachment portion 276 comprises a second recessed portion 278 that defines a groove, gap, space, etc. In some examples, the third attachment portion 276 includes a second non-planar attachment feature 280 disposed on a wall defining the second recessed portion 278. The second non-planar attachment feature 280 includes any number of constructions. In the illustrated example, the second non-planar attachment feature 280 defines a generally circular shape, though other shapes are envisioned. The second non-planar attachment feature 280 can include a plurality of raised and recessed portions, defining a generally undulating profile. In some examples, the second non-planar attachment feature 280 is generally identical to the first non-planar attachment feature 268.

The second connection device 274 can include a fourth attachment opening 282. The fourth attachment opening 282 can define an aperture, recess, space, passageway, etc. that extends through the third attachment portion 276 to the second recessed portion 278. In an example, the fourth attachment opening 282 extends through the second non-planar attachment feature 280.

The second attachment portion 264 of the first connection device 252 can engage the third attachment portion 276 of the second connection device 274. For example, the first non-planar attachment feature 268 of the second attachment portion 264 can mate with and engage the second non-planar attachment feature 280 of the third attachment portion 276. The raised and recessed portions of the first non-planar attachment feature 268 can mate with and engage the raised and recessed portions of the second non-planar attachment feature 280 (e.g., by raised portion being received within recessed portions). This mating/engagement between the first non-planar attachment feature 268 and the second non-planar attachment feature 280 can restrict unintended movement between the first connection device 252 and the second connection device 274.

In some examples, to attach the second attachment portion 264 of the first connection device 252 to the third attachment portion 276 of the second connection device 274, a third fastener 284 is provided. The third fastener 284 comprises any number of structures, such as screws, bolts, nuts, rivets, nails, or the like. In operation, the third fastener 284 can be inserted through the third attachment opening 270 and the fourth attachment opening 282. As such, the third fastener 284 can be tightened to limit inadvertent movement of the first connection device 252 with respect to the second connection device 274. When movement or orientation adjustment is desired, the third fastener 284 can be loosened and/or removed from the third attachment opening 270 and/or the fourth attachment opening 282. Accordingly, the first connection device 252 can be movably adjusted with respect to the second connection device 274.

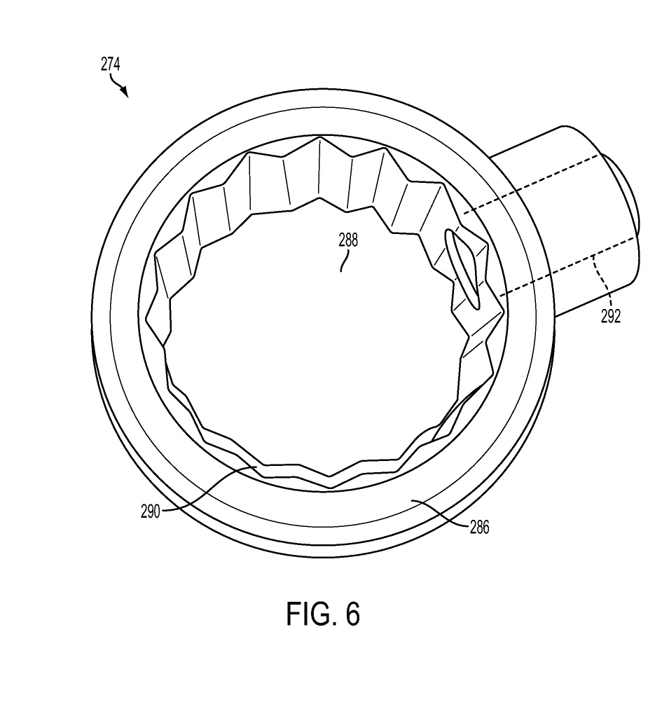

The second connection device 274 includes a fourth attachment portion 286. Referring to FIGS. 2 and 6, the fourth attachment portion 286 is located opposite the third attachment portion 276. In some examples, the fourth attachment portion 286 includes a recess 288 that extends inwardly into the second connection device 274. The fourth attachment portion 286 includes any number of sizes/shapes. In an example, the fourth attachment portion 286 includes a polygonal (e.g., a regular polygon) cross-sectional (illustrated in FIG. 6) comprising a plurality of sides 290. In the illustrated example, the fourth attachment portion 286 includes thirty two sides 290. However, in other examples, the fourth attachment portion 286 includes any number of sides 290, such as by including four sides, six sides, eight sides, etc.

The fourth attachment portion 286 can include a fifth attachment opening 292. The fifth attachment opening 292 can define an aperture, recess, space, passageway, etc. that extends through the fourth attachment portion 286 to the recess 288. In some examples, the fifth attachment opening 292 is sized/shaped to receive a fourth fastener 294. The fourth fastener 294 comprises any number of structures, such as screws, bolts, nuts, rivets, nails, or the like.

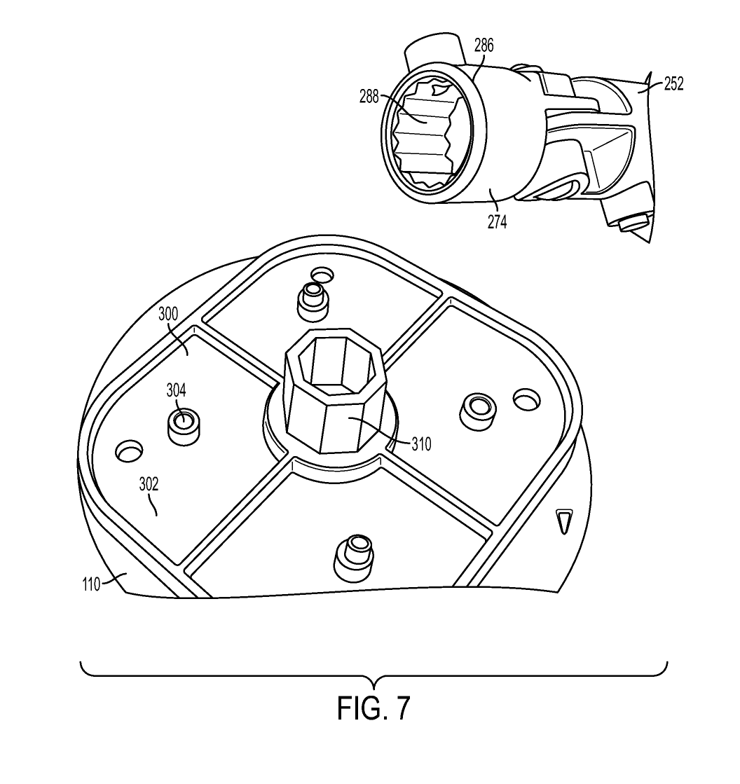

The mounting assembly 120 can include a support portion 300. Referring to FIGS. 2 and 7, the support portion 300 can be removably attached to the sensing device 110. The support portion 300 can be attached to the sensing device 110 in any number of ways. In some examples, the support portion 300 includes a body portion 302 that is substantially planar. The body portion 302 can include one or more attachment openings 304 to allow for attachment between the sensing device 110 and the body portion 302 of the support portion 300. In an example, one or more fasteners (e.g., screws, bolts, nuts, rivets, etc.) can be used to attach the sensing device 110 to the body portion 302 of the support portion 300. In other examples, adhesives, locking structures, snap fit structures, etc., can be used to attach the sensing device 110 to the body portion 302.

The mounting assembly 120 can include a support attachment portion 310. The support attachment portion 310 defines an outwardly protruding extension that projects from the body portion 302. In some examples, the support attachment portion 310 is located on an opposite side of the body portion 302 from the sensing device 110. The support attachment portion 310 includes any number of sizes/shapes. In an example, the support attachment portion 310 includes an octagonal cross-section. However, the support attachment portion 310 is not so limited, and in other examples, includes any number of polygonal shapes (e.g., regular polygonal), such as by having one or more sides and/or including shapes such as triangles, squares, pentagons, hexagons, heptagons, etc.

The fourth attachment portion 286 of the second connection device 274 is sized/shaped to receive the support attachment portion 310. In the illustrated examples, by including thirty two sides 290, the recess 288 of the fourth attachment portion 286 can receive the support attachment portion 310 in sixteen different orientations, thus providing for more finite adjustment of the support attachment portion 310 with respect to the fourth attachment portion 286.

In operation, when the fourth attachment portion 286 receives the support attachment portion 310, the fourth fastener 294 can be inserted through the fifth attachment opening 292 and towards the recess 288. As such, the fourth fastener 294 can contact/engage the support attachment portion 310 within the recess 288. When movement or orientation adjustment is desired, the fourth fastener 294 can be removed from the fifth attachment opening 292, allowing for the support attachment portion 310 to be removed from and/or moved with respect to the fourth attachment portion 286. Accordingly, the support portion 300 can be movably adjusted with respect to the connection portion 250.

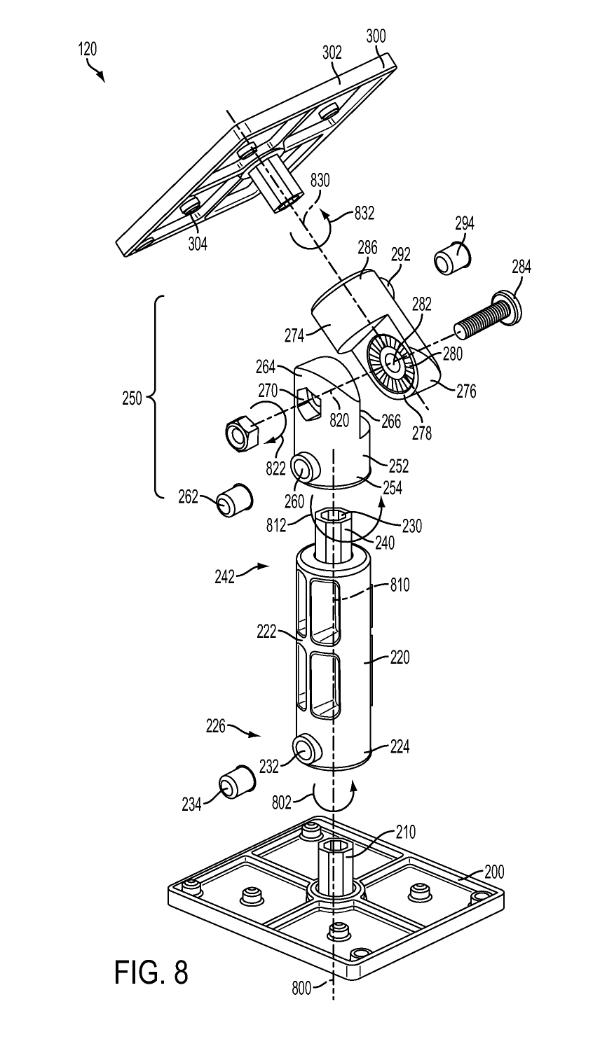

Turning to FIG. 8, movable adjustability of the mounting assembly 120 is illustrated. In this example, the base attachment structure 210 extends along a first axis 800. The extension portion 220 is movably attached with respect to the base portion 200. In an example, the first extension attachment portion 224 can be moved 802 (e.g., illustrated generically/schematically with arrowheads) about the first axis 800 with respect to the base attachment structure 210. For example, the first extension attachment portion 224 of the extension portion 220 can be removed from the base attachment structure 210 and moved 802 clockwise or counter clockwise with respect to the base attachment structure 210.

The extension portion 220 can extend along a second axis 810. In some examples, if the extension portion 220 is substantially linear, as illustrated, the first axis 800 is substantially coaxial with respect to the second axis 810. In other examples, if the extension portion 220 is not linear, such as by including one or more bends, curves, or the like, the first axis 800 is not coaxial with respect to the second axis 810.

In some examples, the connection portion 250 is movably attached with respect to the extension portion 220. For example, the connection portion 250 can be moved 812 about the second axis 810 with respect to the extension portion 220. The first attachment portion 254 of the connection portion 250 can be removed from the second extension attachment portion 240 of the extension portion 220 and moved 812 clockwise or counter clockwise with respect to the extension portion 220.

The connection portion 250 is movable about a third axis 820. In some examples, the first connection device 252 is movable 822 with respect to the second connection device 274. For example, the third fastener 284 may initially be tightened, such that the first non-planar attachment feature 268 of the second attachment portion 264 engages the second non-planar attachment feature 280 of the third attachment portion 276. When tightened, the third fastener 284 limits movement between the first connection device 252 and the second connection device 274. In some examples, the third fastener 284 can be loosened and/or removed from the third attachment opening 270 and the fourth attachment opening 282. Once the third fastener 284 is loosened and/or removed, the second connection device 274 can be moved 822 clockwise or counter clockwise about the third axis 820 with respect to the first connection device 252.

In some examples, the support attachment portion 310 of the support portion 300 and the second connection device 274 extend along a fourth axis 830. In some examples, the fourth axis 830 is substantially angled with respect to at least one of the first axis 800, second axis 810, and third axis 820. In at least one example, the fourth axis 830 is substantially perpendicular with respect to at least one of the first axis 800, second axis 810, and third axis 820. In the illustrated example, the fourth axis 830 is substantially perpendicular to the third axis 820. The support portion 300 is movable 832 about the fourth axis 830 with respect to the second connection device 274 of the connection portion 250. In an example, the support movably attached with respect to the connection portion 250. The fourth fastener 294 can be loosened and/or removed from the fifth attachment opening 292, such that the fourth fastener 294 does not engage the support attachment portion 310. The support attachment portion 310 of the support portion 300 can then be removed from the fourth attachment portion 286 of the connection portion 250. As such, the support portion 300 can be moved 832 clockwise or counter clockwise with respect to the connection portion 250.

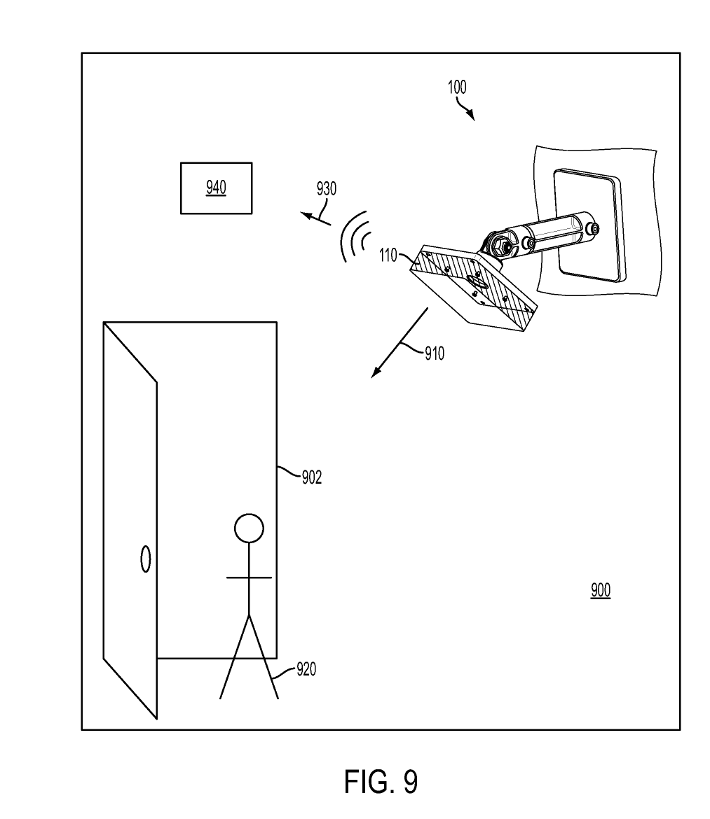

Turning to FIG. 9, an example operation of the sensing assembly 100 is illustrated. In this example, the sensing assembly 100 can be used in a room 900. The room 900 can be located in any number of locations, such as hospitals, nursing homes, restaurants, factories, warehouses, etc. In some examples, the sensing assembly 100 senses entry and exit from the room 900. The sensing assembly 100 may function more effectively when the sensing device 110 is oriented towards a target location 902 within the room 900, such as a doorway, entryway, etc.

The mounting assembly 120 can be attached to one of the surfaces 130 (e.g., walls, floors, ceilings, doors, windows, etc.) within the room 900. The mounting assembly 120, while supporting the sensing device 110, can be moved in any number of directions to orient the sensing device 110 towards the target location 902. For example, as described above with respect to FIG. 8, the extension portion 220 is movably attached 802 about the first axis 800 with respect to the base portion 200. The connection portion 250 is movably attached 812 about the second axis 810 with respect to the extension portion 220. The first connection device 252 of the connection portion 250 is movably attached 822 about the third axis 820 with respect to the second connection device 274 of the connection portion 250. The support portion 300 is movably attached 832 about the fourth axis 830 with respect to the connection portion 250.

With the sensing device 110 oriented towards the target location 902, the sensing device can detect 910 the presence of a person 920 who enters and/or leaves the room 900. The sensing device 110 can detect 910 the person 920 in any number of ways, such as by using infrared technology, motion detection technology, or the like. Once the sensing device 110 detects 910 the person 920 entering/leaving the room 900, the sensing device 110 can transmit 930 this information to a control unit 940. The sensing device 110 can transmit 930 this information in any number of ways, such as by wireless communication, or the like. The control unit 940 can therefore monitor and track the person/people 920 who enter and/or leave the room 900.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different or two identical ends or the same end.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally to be construed to mean “one or more” unless specified otherwise or clear from context to be directed to a singular form. Also, at least one of A and B or the like generally means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A sensing assembly comprising:
a sensing device; and
a mounting assembly for attaching the sensing device to a surface, wherein the mounting assembly is movable with respect to the surface about at least two axes.

2. The sensing assembly of claim 1, wherein the mounting assembly comprises a base portion comprising a base attachment structure.

3. The sensing assembly of claim 2, wherein the base attachment structure comprises a regular polygon cross-section.

4. The sensing assembly of claim 2, wherein the mounting assembly comprises an extension portion comprising a first extension attachment portion and a second extension attachment portion.

5. The sensing assembly of claim 4, wherein the first extension attachment portion defines a recess comprising a polygonal cross-section, the first extension attachment portion configured to receive the base attachment structure.

6. The sensing assembly of claim 4, wherein the second extension attachment portion comprises a regular polygon cross-section.

7. The sensing assembly of claim 4, wherein the mounting assembly comprises a connection portion comprising a first attachment portion and a fourth attachment portion.

8. The sensing assembly of claim 7, wherein the first attachment portion defines a recess comprising a polygonal cross-section, the first attachment portion configured to receive the second extension attachment portion.

9. The sensing assembly of claim 7, wherein the fourth attachment portion defines a recess comprising a polygonal cross-section.

10. The sensing assembly of claim 7, wherein the mounting assembly comprises a support portion comprising a support attachment portion.

11. The sensing assembly of claim 10, wherein the fourth attachment portion is configured to receive the support attachment portion.

12. A sensing assembly comprising:
a sensing device; and
a mounting assembly comprising:
a base portion;
an extension portion movably attached with respect to the base portion;
a connection portion movably attached with respect to the extension portion; and
a support portion movably attached with respect to the connection portion, the support portion supporting the sensing device.

13. The sensing assembly of claim 12, wherein the connection portion comprises a first connection device and a second connection device.

14. The sensing assembly of claim 13, wherein the first connection device comprises a second attachment portion having a first non-planar attachment feature.

15. The sensing assembly of claim 14, wherein the second connection device comprises a third attachment portion having a second non-planar attachment feature.

16. The sensing assembly of claim 15, wherein the second attachment portion of the first connection device engages the third attachment portion of the second connection device such that the second connection device is movable with respect to the first connection device.

17. The sensing assembly of claim 12, wherein the sensing device comprises a room monitor sensor configured to sense entry and exit from a room.

18. A mounting assembly for a sensing device, the mounting assembly comprising:
a base portion;
an extension portion movably attached with respect to the base portion, the extension portion movable about a first axis;
a connection portion movably attached with respect to the extension portion, the connection portion movable about a second axis and about a third axis; and
a support portion movably attached with respect to the connection portion, the support portion movable about a fourth axis, the support portion supporting the sensing device.

19. The mounting assembly of claim 18, wherein the first axis is substantially coaxial with respect to the second axis.

20. The mounting assembly of claim 18, wherein the third axis is substantially perpendicular with respect to at least one of the first axis, the second axis, or the fourth axis.
